(19) United States
(12) Patent Application Publication
(10) Pub. No.: US 2018/0199373 A1
(43) Pub. Date: Jul. 12, 2018

(54) Methods And Apparatus For Interference Management In Mobile Communications

(71) Applicant: MediaTek Inc., Hsinchu City (TW)

(72) Inventors: Weidong Yang, San Jose, CA (US); Bo-Si Chen, Hsinchu City (TW); Chien-Chang Li, Hsinchu City (TW)

(21) Appl. No.: 15/862,873

(22) Filed: Jan. 5, 2018

Related U.S. Application Data
(60) Provisional application No. 62/444,334, filed on Jan. 9, 2017.

(51) Int. Cl. H04W 74/08; H04W 52/24

(52) U.S. Cl. CPC H04W 74/0808; H04W 24/08; H04W 52/243

(57) ABSTRACT

Various solutions for interference management with respect to user equipment and network apparatus in mobile communications are described. A first node of a first link in a wireless network may sense transmission from at least one of a third node and a fourth node of a second link in the wireless network. The first node may further determine whether to transmit signals to a second node of the first link according to a sensing result. The first link may be established between the first node and the second node. The second link may be established between the third node and the fourth node.

### CROSS REFERENCE TO RELATED PATENT APPLICATION

The present disclosure claims the priority benefit of U.S. Provisional Patent Application No. 62/444,334, filed on 9 Jan. 2017, the content of which is incorporated by reference in its entirety.

### TECHNICAL FIELD

The present disclosure is generally related to mobile communications and, more particularly, to interference management with respect to user equipment and network apparatus in mobile communications.

### BACKGROUND

Unless otherwise indicated herein, approaches described in this section are not prior art to the claims listed below and are not admitted as prior art by inclusion in this section.

In wireless communication environment, the wireless signals transmitted or broadcasted by a node of a wireless network may cause interferences to neighbor nodes within neighbor areas. In order to prevent potential interferences, the plurality of nodes within neighbor areas may have to communicate and negotiate with each other to properly arrange radio resources and mitigate interference. Accordingly, proper interference management schemes among the plurality of nodes may be needed.

In Long-Term Evolution (LTE), some interference management schemes such as Inter-Cell Interference Coordination (ICIC), enhanced ICIC (eICIC), Coordinated Multi-Point Transmission (CoMP), enhanced CoMP (eCoMP) were developed. The network may proactively reduce interferences to neighboring cells. However, these schemes were developed for handling inter-cell interference. Although enhanced Interference Mitigation and Traffic Adaptation (eIMTA) was proposed for handling cross-link interference, it requires information exchange between nodes through backhaul links and regular frame structures. In New Radio (NR), dynamic time division duplex (TDD) and mini-slot transmission were introduced for more dynamic and flexible information exchange between nodes. Also, over-the-air (OTA) signaling was adopted for more efficient communications among cells. Other cell interferences may be much more dynamic than in LTE. Both UEs and cells may suffer from more cross-link interference.

Especially in the unlicensed spectrum, the plurality of nodes in neighbor areas may not belong to the same operator networks or service providers. The timing information of the nodes may not be shared or aligned with each other. If the coordination information is not well exchanged between the nodes, the interferences among the nodes may become serious and uncontrollable.

Accordingly, it is important to properly avoid interferences caused by non-coordinated wireless signal transmission. Therefore, in developing communication system, it is needed to provide proper mechanisms for more real-time interference management among a plurality of nodes.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to interference management among a plurality of nodes with respect to user equipment and network apparatus in mobile communications.

In one aspect, a method may involve a first node of a first link in a wireless network sensing transmission from at least one of a third node and a fourth node of a second link in the wireless network. The method may also involve the first node determining whether to transmit signals to a second node of the first link according to a sensing result. The first link may be established between the first node and the second node. The second link may be established between the third node and the fourth node.

In one aspect, an apparatus configured as a first node of a first link in a wireless network may comprise a transceiver capable of wirelessly communicating with a plurality of nodes of the wireless network. The apparatus may also comprise a processor communicatively coupled to the transceiver. The processor may be capable of sensing transmission from at least one of a third node and a fourth node of a second link in the wireless network. The processor may also be capable of determining whether to transmit signals to a second node of the first link according to a sensing result. The first link may be established between the first node and the second node. The second link may be established between the third node and the fourth node.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR) and Internet-of-Things (IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a diagram depicting an example scenario under schemes in accordance with implementations of the present disclosure.

FIG. 8 is a diagram depicting an example scenario under schemes in accordance with implementations of the present disclosure.

FIG. 9 is a diagram depicting an example scenario under schemes in accordance with implementations of the present disclosure.

FIG. 10 is a diagram depicting an example scenario under schemes in accordance with implementations of the present disclosure.

FIG. 11 is a diagram depicting an example scenario under schemes in accordance with implementations of the present disclosure.

FIG. 12 is a block diagram of an example system in accordance with an implementation of the present disclosure.

FIG. 13 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to interference management with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In Long-Term Evolution (LTE), some interference management schemes such as Inter-Cell Interference Coordination (ICIC), enhanced ICIC (eICIC), Coordinated Multi-Point Transmission (CoMP), enhanced CoMP (eCoMP) were developed. The network may proactively reduce interferences to neighboring cells. However, these schemes were developed for handling inter-cell interference. Although enhanced Interference Mitigation and Traffic Adaptation (eIMTA) was proposed for handling cross-link interference, it requires information exchange between nodes through backhaul links and regular frame structures. In New Radio (NR), dynamic time division duplex (TDD) and mini-slot transmission were introduced for more dynamic and flexible information exchange between nodes. Also, over-the-air (OTA) signaling was adopted for more efficient communications among cells. Other cell interferences may be much more dynamic than in LTE. Both UEs and cells may suffer from more cross-link interference.

Especially in the unlicensed spectrum, the plurality of nodes in neighbor areas may not belong to the same operator networks or service providers. The timing information of the nodes may not be shared or aligned with each other. If the coordination information is not well exchanged between the nodes, the interferences among the nodes may become serious and uncontrollable. According, solutions and schemes for more real-time interference management are proposed in the present disclosure.

Under proposed schemes in accordance with the present disclosure, interference management may occur among nodes in a wireless network. Each node in the wireless network may be a network apparatus (e.g., a base station (BS)) or a communication apparatus (e.g., a user equipment (UE)), and a UE may be engaged in communication with a BS, another UE, or both, at a given time. Thus, the interference management may associate three types of node pairs: BS-BS, BS-UE and UE-UE. Herein, a BS may be an eNB in an LTE-based network or a gNB in a 5G/NR network.

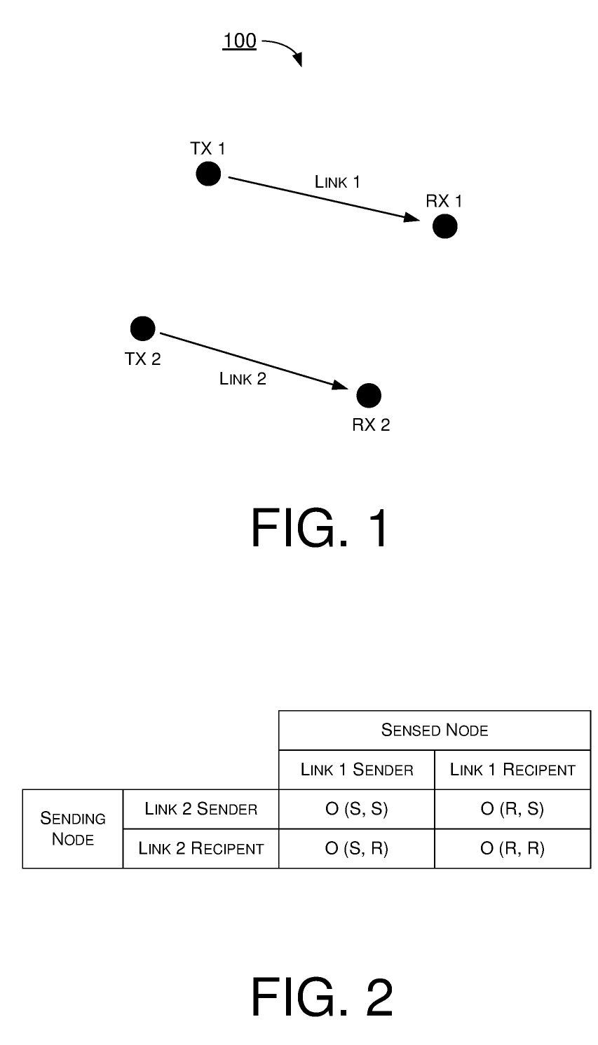

FIG. 1 illustrates an example scenario 100 under schemes in accordance with implementations of the present disclosure. Scenario 100 involves a plurality of nodes including TX 1, RX 1, TX 2 and RX 2, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). Each of the nodes may be either a gNB or a UE in the communication network. The plurality of nodes may be capable of wirelessly communicating with each other via wireless signals. FIG. 1 illustrates two data links including link 1 and link 2. Link 1 may be established between TX 1 and RX 1. Link 2 may be established between TX 2 and RX 2. A sender may be used for representing a node transmitting signals in a data link (e.g., TX 1 or TX 2). A recipient may be used for representing a node receiving signals in a data link (e.g., RX 1 or RX 2). In addition to performing data transmission, each node may be able to perform functions such as transmitting a signal which may be used to facilitate sensing based coordination or interference management.

The concept of sensed node and sensing node may also be introduced. For example, the sensed node may stand for a node from link 1 (e.g., TX 1 or RX 1) generating a signal which may be sensed by another node from link 2. The sensing node may stand for a node from link 2 (e.g., TX 2 or RX 2) sensing a signal which may be transmitted by another node from link 1. Therefore, there may be four combinations in a sensing based design for illustrating the schemes in accordance with implementations of the present disclosure.

FIG. 2 illustrates example combinations under schemes in accordance with implementations of the present disclosure. The representation O(X, Y) stands for that X in link 1 (e.g., TX 1 or RX 1) may be the sensed node and Yin link 2 (e.g., TX 2 or RX 2) may be the sensing node. In the combination O(S, S), the sender from link 1 may transmit a signal which may be sensed by the sender from link 2. The sensing result may help the sender in link 2 make decisions. In the combination O(R, S), the recipient from link 1 may transmit a signal which may be sensed by the sender from link 2. The sensing result may help the sender in link 2 make decisions. In the combination O(S, R), the sender from link 1 may transmit a signal which may be sensed by the recipient from link 2. The recipient in link 2 may inform the sender in link 2 of the sensing result which may help the sender in link 2 make decisions. In the combination O(R, R), the recipient from link 1 may transmit a signal which may be sensed by the recipient from link 2. The recipient in link 2 may inform the sender in link 2 of the sensing result which may help the sender in link 2 make decisions.

Alternatively and additionally, the sensed node may be a node from link 2 (e.g., TX 2 or RX 2) generating a signal which may be sensed by another node from link 1. The sensing node may be a node from link 1 (e.g., TX 1 or RX 1) sensing a signal which may be transmitted by another node from link 2. Either a base station or a UE may be a potential transmitter of the sensing nodes. The potential transmitter may have more nuanced decisions in transmission in accordance with sensing based schemes of the present disclosure.

Specifically, when a UE is chosen to be the sensing node, the base station may provide a transmission grant including all transmission parameters (e.g., resource allocation, hybrid automatic repeat request (HARQ) ID) to the UE. The UE may be configured to make decisions in transmission according to the sensing result. The decisions may comprise at least one of determining whether to transmit signals or not, adjusting a transmission power level, and determining a modulation and coding scheme (MCS) level. As the base station may not know the MCS level chosen by the UE, the UE may further indicate the chosen MCS level in the uplink transmission. On the other hand, when a base station is chosen to be the sensing node, the base station may be configured to make decisions according to the sensing result. The decisions may comprise at least one of determining whether to transmit signals or not, adjusting a transmission power level, determining a modulation and coding scheme (MCS) level, and sending the chosen MCS level to the UE.

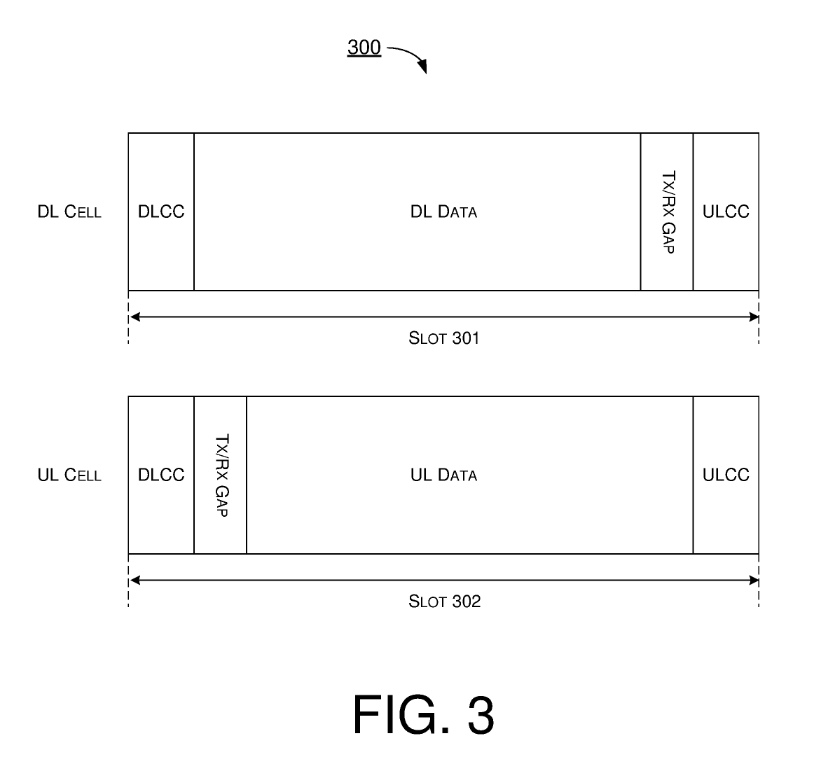

FIG. 3 illustrates an example scenario 300 under schemes in accordance with implementations of the present disclosure. Scenario 300 involves a plurality of nodes including a downlink (DL) cell, a DL UE, an uplink (UL) cell and a UL UE, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). In dynamic TDD, slots may be categorized according to their usage including a mixed slot, an UL prioritized slot and a DL prioritized slot. In the mixed slot, each cell may conduct DL or UL transmission. In the UL prioritized slot, the cell intending to conduct DL transmission should perform sensing mechanism before data transmission to ensure it may not impact UL transmission at other cells. Similarly, in the DL prioritized slot, if UL transmission is intended in a cell, either the cell or the UE should perform sensing mechanism before data transmission to ensure it may not impact DL transmission at other cells. Some scenarios for UL prioritized and DL prioritized opportunistic transmission may be described and illustrated in the following paragraphs and figures.

FIG. 3 illustrates mixed slot 301 for a DL cell and mixed slot 302 for an UL cell. Slot 301 may comprise a DL control channel (DLCC) region, a DL data region, a transmit/receive (Tx/Rx) transition gap and an UL control channel (ULCC) region. The DLCC region may be used for the DL cell to transmit DL control information to the DL UE. The DL data region may be used for the DL cell to transmit DL data to the DL UE. The Tx/Rx transition gap may be reserved for the DL UE to perform DL to UL transition. The ULCC region may be used for the DL UE to transmit UL control information to the DL cell. Slot 302 may comprise a DLCC region, a Tx/Rx transition gap, an UL data region and an ULCC region. The DLCC may be used for the UL cell to transmit DL control information to the UL UE. The Tx/Rx transition gap may be reserved for the UL UE to perform DL to UL transition. The UL data region may be used for the UL UE to transmit UL data to the UL cell. The ULCC region may be used for the UL UE to transmit UL control information to the UL cell. UL Prioritized Opportunistic Transmission

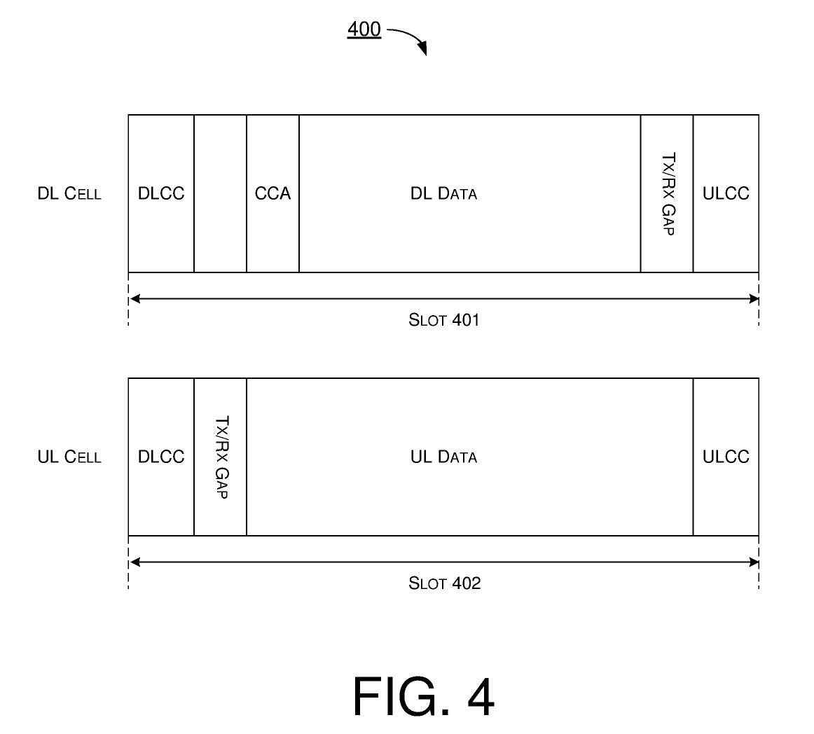

FIG. 4 illustrates an example scenario 400 under schemes in accordance with implementations of the present disclosure. Scenario 400 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a DL cell. The second node may be a DL UE. The third node may be a UL cell. The fourth node may be a UL UE. A first link may be established between the first node (e.g., DL cell) and the second node (e.g., DL UE) for DL data transmission. A second link may be established between the third node (e.g., UL cell) and the fourth node (e.g., UL UE) for UL data transmission. The DL cell may be configured to transmit the control information to the DL UE in the DLCC region of slot 401. The UL cell may be configured to transmit the control information to the UL UE in the DLCC region of slot 402. The UL UE may be configured to transmit the UL data to the UL cell in the UL data region of slot 402. The DL cell may be configured to sense the transmission from the UL UE in the clear channel assessment (CCA) region of slot 401. The CCA region may be used by the DL cell for sensing whether any signals may be transmitted from other nodes before transmitting the DL data to the DL UE. After sensing the transmission from the UL UE, the DL cell may be configured to make decisions according to the sensing result. The decisions may comprise at least one of determining whether to transmit signals or not, adjusting a transmission power level and determining a MCS level. For example, if the DL cell senses the transmission from the UL UE (e.g., UL data), the DL cell may determine not to transmit the DL data to the DL UE to avoid interfering the transmission from the UL UE. In the UL prioritized opportunistic transmission, the UL transmission between the UL cell and the UL UE may have higher priority. Accordingly, the DL cell may have to sense before transmission and adjust its transmission according to the sensing result.

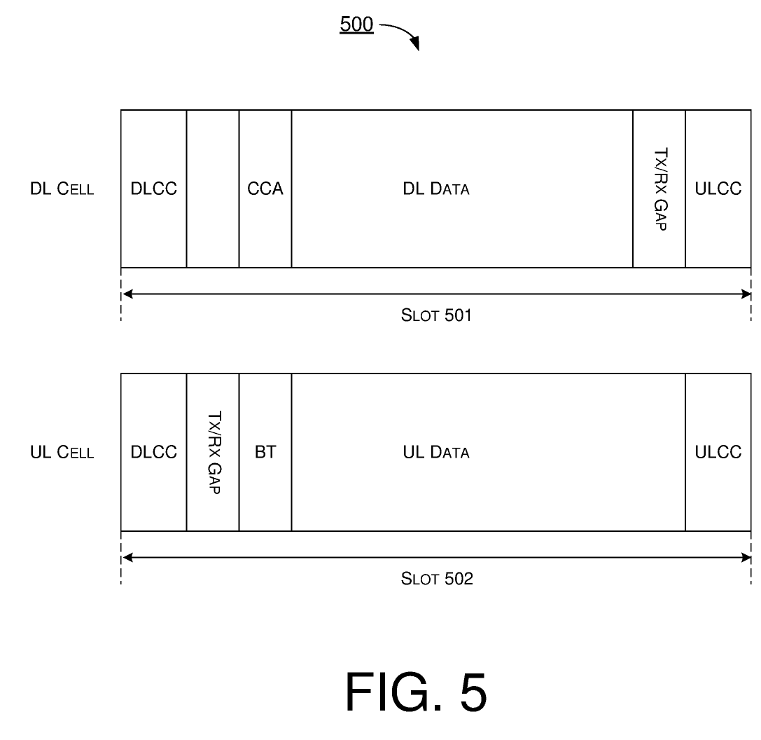

FIG. 5 illustrates an example scenario 500 under schemes in accordance with implementations of the present disclosure. Scenario 500 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a DL cell. The second node may be a DL UE. The third node may be a UL cell. The fourth node may be a UL UE. A first link may be established between the first node (e.g., DL cell) and the second node (e.g., DL UE) for DL data transmission. A second link may be established between the third node (e.g., UL cell) and the fourth node (e.g., UL UE) for UL data transmission. The DL cell may be configured to transmit the control information to the DL UE in the DLCC region of slot 501. The UL cell may be configured to transmit the control information to the UL UE in the DLCC region of slot 502. Instead of transmitting the UL data, the UL UE may be configured to transmit a busy tone (BT) first over the physical resource blocks (PRBs) scheduled by the UL cell (e.g., the BT region of slot 502).

The busy tone which may also be called the busy signal may be used to facilitate the sensing mechanism at other nodes. Specifically, the busy tone may have some structures similar to, for example and without limitation, sounding reference signal (SRS), channel state information-reference signal (CSI-RS) or demodulation-reference signal (DM-RS). The busy tone may be used for detecting signal strength. Additional channel estimation and advanced precoding schemes may be conducted based on the busy tone. The busy tone may further comprise the identity information and/or the beam direction information of the transmitting node. The busy tone may also be used to indicate that a specific channel may be occupied for transmission. After receiving the busy tone, the receiving node may be aware of the identity, the beam direction, or the possible transmission from the transmitting node and may use these information for further decisions.

The DL cell may be configured to sense the transmission from the UL UE in the CCA region of slot 501. The CCA region may be used by the DL cell for sensing whether any signals may be transmitted from other nodes before transmitting the DL data to the DL UE. The timing of the CCA region of slot 501 may correspond to the timing of the BT region of slot 502. Accordingly, the DL cell may sense the BT transmitted from the UL UE. After sensing the BT from the UL UE, the DL cell may be configured to make decisions according to the sensing result. The decisions may comprise at least one of determining whether to transmit signals or not, adjusting a transmission power level and determining a MCS level. For example, if the DL cell senses the beam direction of the UL UE based on the BT transmitted from the UL UE, the DL cell may determine not to transmit signals toward the beam direction of the UL UE to avoid interfering the transmission from the UL UE.

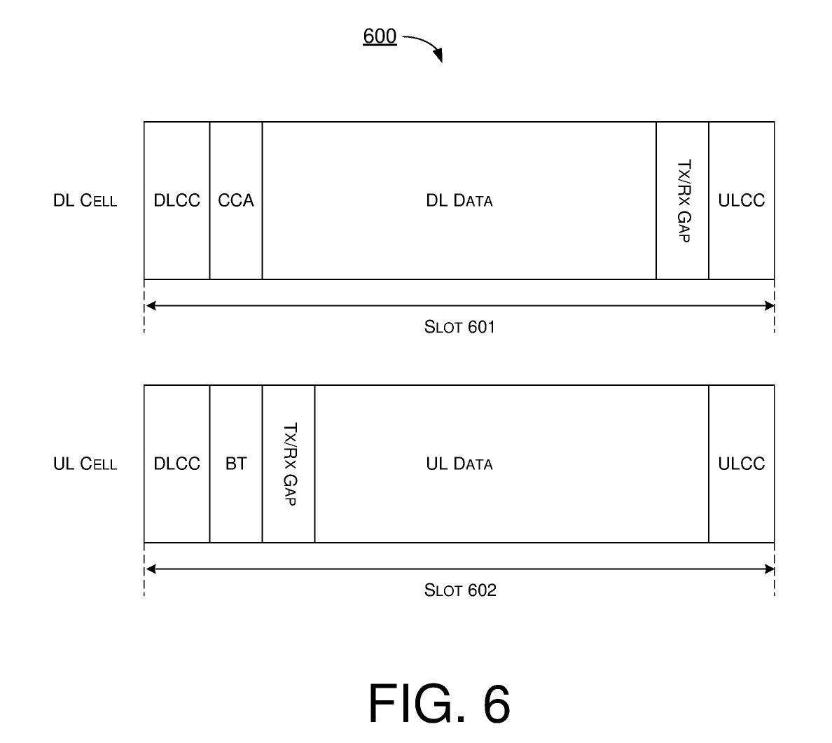

FIG. 6 illustrates an example scenario 600 under schemes in accordance with implementations of the present disclosure. Scenario 600 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a DL cell. The second node may be a DL UE. The third node may be a UL cell. The fourth node may be a UL UE. A first link may be established between the first node (e.g., DL cell) and the second node (e.g., DL UE) for DL data transmission. A second link may be established between the third node (e.g., UL cell) and the fourth node (e.g., UL UE) for UL data transmission. The DL cell may be configured to transmit the control information to the DL UE in the DLCC region of slot 601. The UL cell may be configured to transmit the control information to the UL UE in the DLCC region of slot 602. The UL cell may be further configured to transmit a BT in the BT region of slot 602 before receiving the UL data. The DL cell may be configured to sense the transmission from the UL cell in the CCA region of slot 601. The CCA region may be used by the DL cell for sensing whether any signals may be transmitted from other nodes before transmitting the DL data to the DL UE. The timing of the BT region of slot 602 may correspond to the timing of the CCA region of slot 601. Accordingly, the DL cell may sense the BT transmitted from the UL cell. After sensing the BT from the UL cell, the DL cell may be configured to make decisions according to the sensing result. The decisions may comprise at least one of determining whether to transmit signals or not, adjusting a transmission power level and determining a MCS level. For example, the BT may indicate that the UL transmission may occur at the UL cell. The DL cell may determine not to transmit signals to avoid interfering the UL transmission at the UL cell.

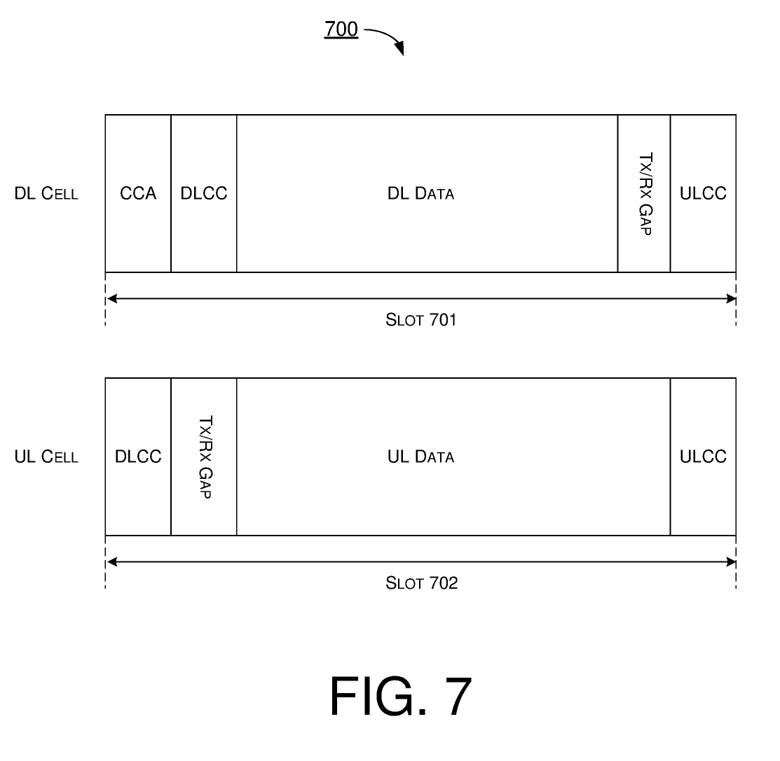

FIG. 7 illustrates an example scenario 700 under schemes in accordance with implementations of the present disclosure. Scenario 700 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a DL cell. The second node may be a DL UE. The third node may be a UL cell. The fourth node may be a UL UE. A first link may be established between the first node (e.g., DL cell) and the second node (e.g., DL UE) for DL data transmission. A second link may be established between the third node (e.g., UL cell) and the fourth node (e.g., UL UE) for UL data transmission. The UL cell may be configured to transmit the control information to the UL UE in the DLCC region of slot 702. The DL cell may be configured to sense the transmission from the UL cell in the CCA region of slot 701. The CCA region may be used by the DL cell for sensing whether any signals may be transmitted from other nodes before transmitting the DL data to the DL UE. The timing of the CCA region of slot 701 may correspond to the timing of the DLCC region of slot 702. Accordingly, the DL cell may sense the control information transmitted from the UL cell. After sensing the control information from the UL cell, the DL cell may be configured to make decisions according to the sensing result. The decisions may comprise at least one of determining whether to transmit signals or not, adjusting a transmission power level and determining a MCS level. For example, the control information may comprise UL scheduling information for the UL UE. After sensing the control information, the DL cell may be aware of that the UL transmission may occur at the UL cell and may determine not to transmit signals to avoid interfering the UL transmission at the UL cell.

In this scenario, since the DL cell firstly allocate the CCA region in slot 701 for sensing the control information from the UL cell, the DL cell may shift the location of the DLCC region after the CCA region. The DL cell may be configured to transmit the downlink control information to the DL UE in the DLCC region after the CCA region of slot 701. Accordingly, the DL cell may further be configured to indicate the slot type or slot format to the DL UE in advance. The indication may be transmitted in the DL control information in a previous slot. Alternatively, if the DL cell does not indicate the change of the slot type, the DL UE may need to blindly detect the control channel location. DL Prioritized Opportunistic Transmission

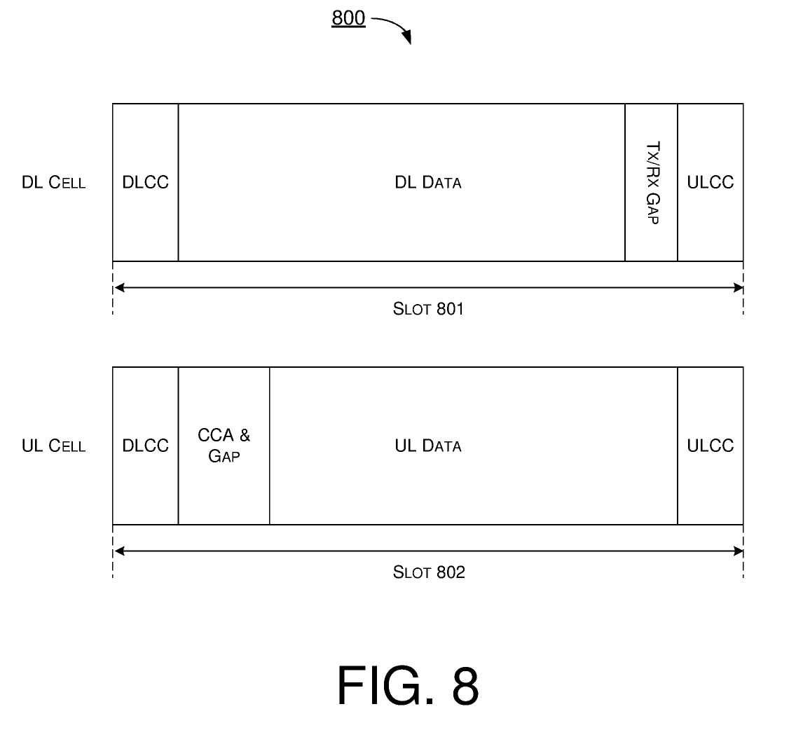

FIG. 8 illustrates an example scenario 800 under schemes in accordance with implementations of the present disclosure. Scenario 800 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a UL UE. The second node may be a UL cell. The third node may be a DL UE. The fourth node may be a DL cell. A first link may be established between the first node (e.g., UL UE) and the second node (e.g., UE cell) for UL data transmission. A second link may be established between the third node (e.g., DL UE) and the fourth node (e.g., DL cell) for DL data transmission. The DL cell may be configured to transmit the control information to the DL UE in the DLCC region of slot 801. The UL cell may be configured to transmit the control information to the UL UE in the DLCC region of slot 802. The DL cell may be configured to transmit the DL data to the DL UE in the DL data region of slot 801. The UL UE may be configured to sense the transmission from the DL cell in the CCA and gap region of slot 802. In this scenario, the CCA region and the gap region may be combined together. The CCA region may be used by the UL UE for sensing whether any signals may be transmitted from other nodes before transmitting the UL data to the UL cell. After sensing the transmission from the DL cell, the UL UE may be configured to make decisions according to the sensing result. The decisions may comprise at least one of determining whether to transmit signals or not, adjusting a transmission power level and determining a MCS level. For example, if the UL UE senses the transmission from the DL cell, the UL UE may determine not to transmit the UL data to the UE cell to avoid interfering the transmission from the DL cell. In the DL prioritized opportunistic transmission, the DL transmission between the DL cell and the DL UE may have higher priority. Accordingly, the UL UE may have to sense before transmission and adjust its transmission according to the sensing result.

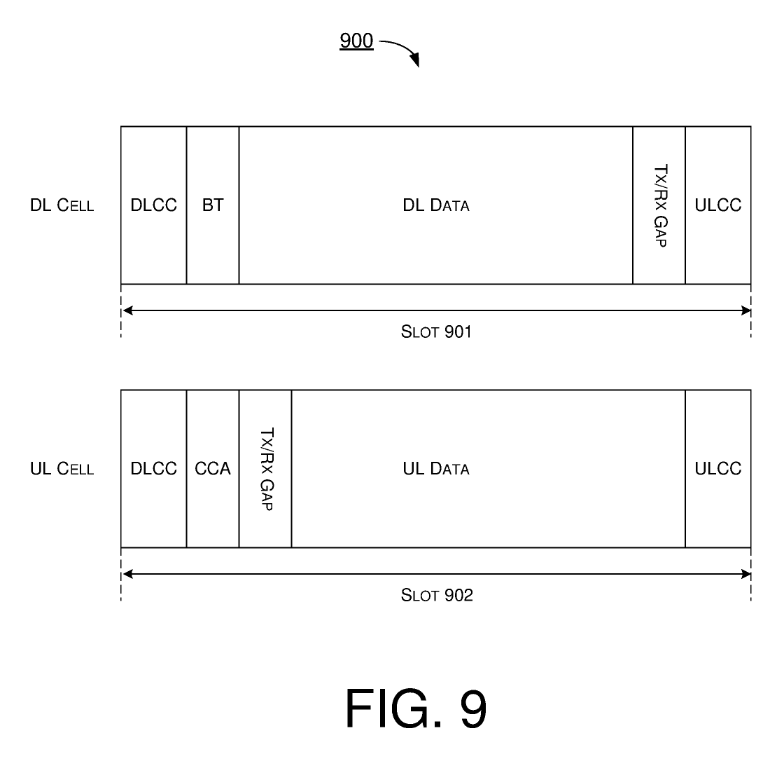

FIG. 9 illustrates an example scenario 900 under schemes in accordance with implementations of the present disclosure. Scenario 900 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a UL UE. The second node may be a UL cell. The third node may be a DL UE. The fourth node may be a DL cell. A first link may be established between the first node (e.g., UL UE) and the second node (e.g., UE cell) for UL data transmission. A second link may be established between the third node (e.g., DL UE) and the fourth node (e.g., DL cell) for DL data transmission. The DL cell may be configured to transmit the control information to the DL UE in the DLCC region of slot 901. The UL cell may be configured to transmit the control information to the UL UE in the DLCC region of slot 902. Instead of transmitting the DL data, the DL cell may be configured to transmit a BT first over the scheduled DL PRBs (e.g., the BT region of slot 901). The UL UE may be configured to sense the transmission from the DL cell in the CCA region of slot 902. The CCA region may be used by the UL UE for sensing whether any signals may be transmitted from other nodes before transmitting the UL data to the UL cell. The timing of the CCA region of slot 902 may correspond to the timing of the BT region of slot 901. Accordingly, the UL UE may sense the BT transmitted from the DL cell. After sensing the BT from the DL cell, the UL UE may be configured to make decisions according to the sensing result. The decisions may comprise at least one of determining whether to transmit signals or not, adjusting a transmission power level and determining a MCS level. For example, if the UL UE senses the beam direction of the DL cell based on the BT transmitted from the DL cell, the UL UE may determine not to transmit signals toward the beam direction of the DL cell to avoid interfering the transmission from the DL cell.

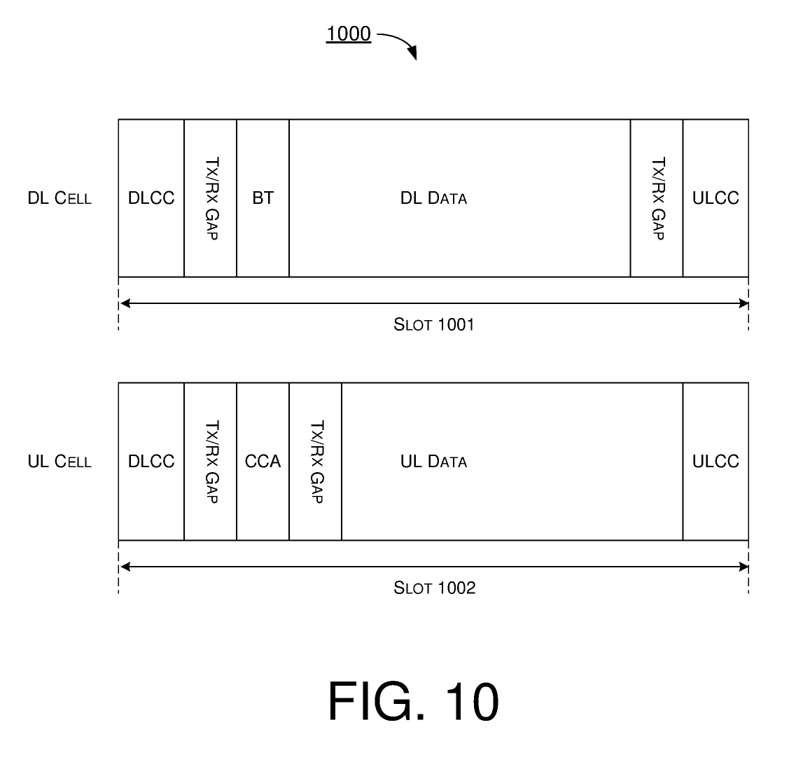

FIG. 10 illustrates an example scenario 1000 under schemes in accordance with implementations of the present disclosure. Scenario 1000 involves a plurality of nodes including a first node, a second node, a third node and a fourth node, which may be a part of a wireless communication network (e.g., a Long-Term Evolution (LTE) network, a LTE-Advanced network, a LTE-Advanced Pro network, a 5th Generation (5G) network, a New Radio (NR) network or an Internet of Things (IoT) network). The first node may be a UL UE. The second node may be a UL cell. The third node may be a DL UE. The fourth node may be a DL cell. A first link may be established between the first node (e.g., UL UE) and the second node (e.g., UE cell) for UL data transmission. A second link may be established between the third node (e.g., DL UE) and the fourth node (e.g., DL cell) for DL data transmission. The DL cell may be configured to transmit the control information to the DL UE in the DLCC region of slot 1001. The UL cell may be configured to transmit the control information to the UL UE in the DLCC region of slot 1002. The DL UE may be configured to transmit a BT over the PRBs schedule by the DL cell (e.g., the BT region of slot 1001). The UL UE may be configured to sense the transmission from the DL UE in the CCA region of slot 1002. The CCA region may be used by the UL UE for sensing whether any signals may be transmitted from other nodes before transmitting the UL data to the UL cell. The timing of the CCA region of slot 1002 may correspond to the timing of the BT region of slot 1001. Accordingly, the UL UE may sense the BT transmitted from the DL UE. After sensing the BT from the DL UE, the UL UE may be configured to make decisions according to the sensing result. The decisions may comprise at least one of determining whether to transmit signals or not, adjusting a transmission power level and determining a MCS level. For example, the BT may indicate that the DL transmission may occur at the DL UE. The DL cell may determine not to transmit signals to avoid interfering the DL transmission at the DL UE.

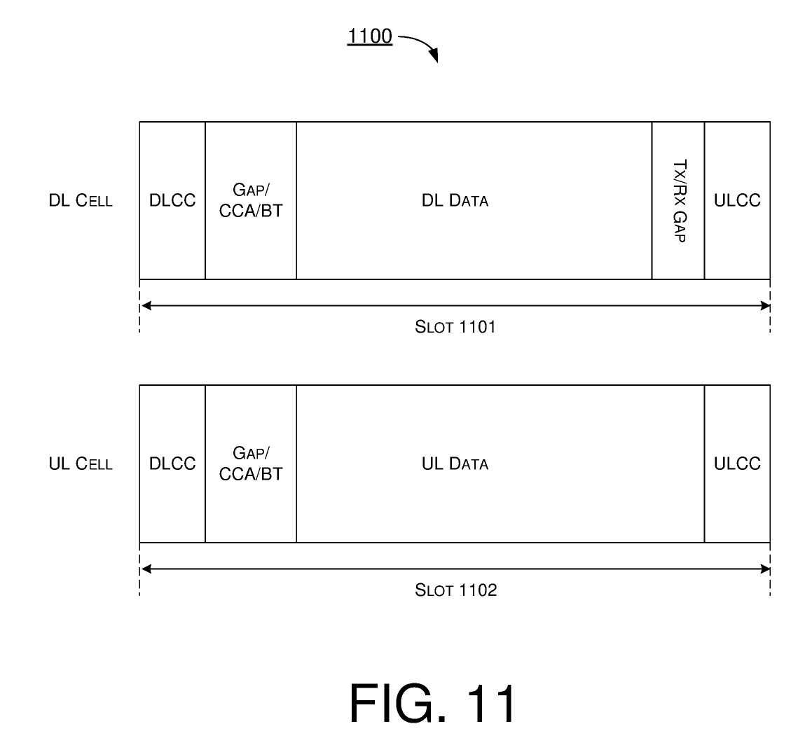

FIG. 11 illustrates an example scenario 1100 under schemes in accordance with implementations of the present disclosure. Scenario 1100 illustrates two unified slot formats for the DL transmission and UL transmission respectively. Slot 1101 may comprise a DLCC region, a combined region (e.g., gap/CCA/BT region), a DL data region, a Tx/Rx transition gap and a ULCC region. The DLCC region may be used for the DL cell to transmit DL control information to the DL UE. The combined region may be used for performing at least one of Tx/Rx transition, CCA and BT transmission. The DL data region may be used for the DL cell to transmit DL data to the DL UE. The Tx/Rx transition gap may be reserved for the DL UE to perform DL to UL transition. The ULCC region may be used for the DL UE to transmit UL control information to the DL cell. Slot 1102 may comprise a DLCC region, a combined region (e.g., gap/CCA/BT region), an UL data region and a ULCC region. The DLCC may be used for the UL cell to transmit DL control information to the UL UE. The combined region may be used for performing at least one of Tx/Rx transition, CCA and BT transmission. The UL data region may be used for the UL UE to transmit UL data to the UL cell. The ULCC region may be used for the UL UE to transmit UL control information to the UL cell.

For a cell with higher priority, the period of the combined region (e.g., gap/CCA/BT region) may be shortened or introducing a BT in the combined region. The cell with lower priority may be configured to sense the signal from the higher priority cell. For example, if the combined region is shortened in the UL cell, then it may become scenario 400 in the UL prioritized opportunistic transmission. Accordingly, instead of prioritizing between DL and UL, by using this unified method, it may adaptively create different priority classes among DL cells or UL cells. In other words, by adjusting the CCA location at a sensing node and the transmission time of data/control and/or BT from a higher priority link, different levels of priority may be created.

In some implementations, power control of the BT may provide some flexibility in the sensing based schemes. In other words, different levels of protections may be created by adjusting the transmission power of the BT. For example, if a recipient in a data link detects that the signals from a sender may be weak, the recipient may send out a BT with high power level to mute other nodes in an extended area surrounding the recipient. In this way, more sensing nodes may be prohibited from transmission or the sensing nodes may reduce its transmission power. Accordingly, the recipient may get a better protection of its transmission and reception.

### Illustrative Implementations

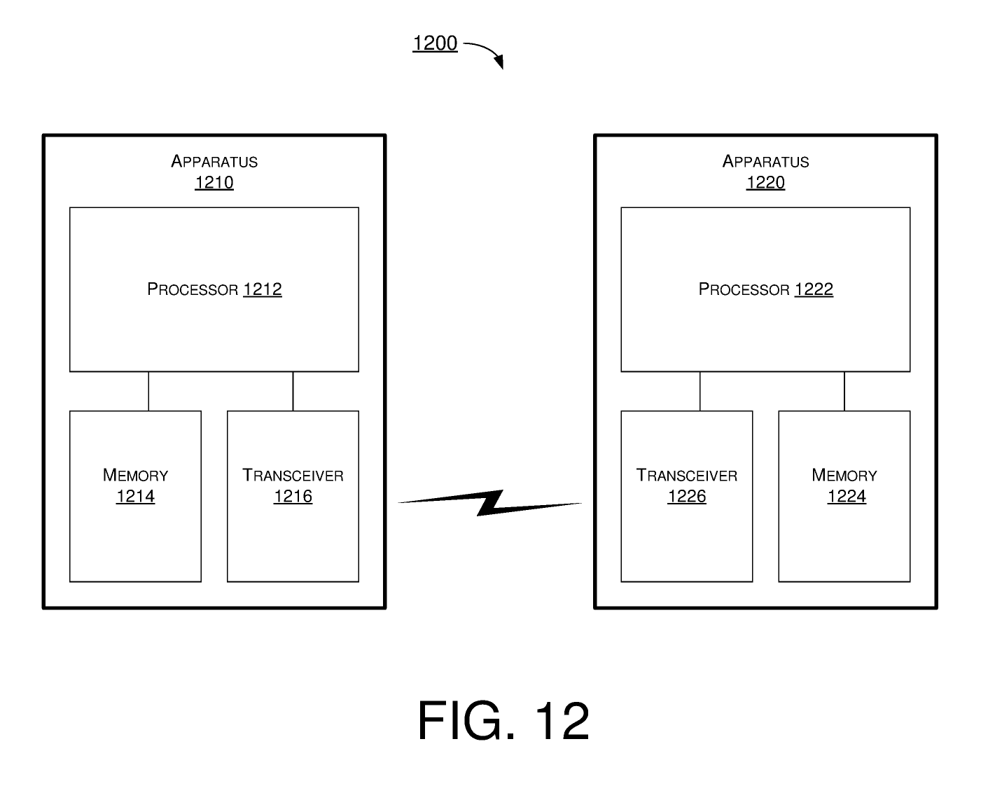

FIG. 12 illustrates an example system 1200 having at least an example apparatus 1210 and an example apparatus 1220 in accordance with an implementation of the present disclosure. Each of apparatus 1210 and apparatus 1220 may perform various functions to implement schemes, techniques, processes and methods described herein pertaining to interference management in wireless communication systems, including the various schemes described above with respect to FIG. 1-FIG. 11 described above as well as process 1300 described below.

Each of apparatus 1210 and apparatus 1220 may be a part of an electronic apparatus, which may be a network apparatus or a UE, such as a portable or mobile apparatus, a wearable apparatus, a wireless communication apparatus or a computing apparatus. For instance, each of apparatus 1210 and apparatus 1220 may be implemented in a smartphone, a smartwatch, a personal digital assistant, a digital camera, or a computing equipment such as a tablet computer, a laptop computer or a notebook computer. Each of apparatus 1210 and apparatus 1220 may also be a part of a machine type apparatus, which may be an IoT apparatus such as an immobile or a stationary apparatus, a home apparatus, a wire communication apparatus or a computing apparatus. For instance, each of apparatus 1210 and apparatus 1220 may be implemented in a smart thermostat, a smart fridge, a smart door lock, a wireless speaker or a home control center. When implemented in or as a network apparatus, apparatus 1210 and/or apparatus 1220 may be implemented in an eNodeB in a LTE, LTE-Advanced or LTE-Advanced Pro network or in a gNB or TRP in a 5G network, an NR network or an IoT network.

In some implementations, each of apparatus 1210 and apparatus 1220 may be implemented in the form of one or more integrated-circuit (IC) chips such as, for example and without limitation, one or more single-core processors, one or more multi-core processors, or one or more complex-instruction-set-computing (CISC) processors. In the various schemes described above with respect to FIG. 1-FIG. 11, each of apparatus 1210 and apparatus 1220 may be implemented in or as a network apparatus or a UE. Each of apparatus 1210 and apparatus 1220 may include at least some of those components shown in FIG. 12 such as a processor 1212 and a processor 1222, respectively, for example. Each of apparatus 1210 and apparatus 1220 may further include one or more other components not pertinent to the proposed scheme of the present disclosure (e.g., internal power supply, display device and/or user interface device), and, thus, such component(s) of apparatus 1210 and apparatus 1220 are neither shown in FIG. 12 nor described below in the interest of simplicity and brevity.

In one aspect, each of processor 1212 and processor 1222 may be implemented in the form of one or more single-core processors, one or more multi-core processors, or one or more CISC processors. That is, even though a singular term “a processor” is used herein to refer to processor 1212 and processor 1222, each of processor 1212 and processor 1222 may include multiple processors in some implementations and a single processor in other implementations in accordance with the present disclosure. In another aspect, each of processor 1212 and processor 1222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1212 and processor 1222 is a special-purpose machine specifically designed, arranged and configured to perform specific tasks including those pertaining to alert signal design in wireless communication systems in accordance with various implementations of the present disclosure.

In some implementations, apparatus 1210 may also include a transceiver 1216 coupled to processor 1212. Transceiver 1216 may be capable of wirelessly transmitting and receiving data. In some implementations, apparatus 1220 may also include a transceiver 1226 coupled to processor 1222. Transceiver 1226 may include a transceiver capable of wirelessly transmitting and receiving data.

In some implementations, apparatus 1210 may further include a memory 1214 coupled to processor 1212 and capable of being accessed by processor 1212 and storing data therein. In some implementations, apparatus 1220 may further include a memory 1224 coupled to processor 1222 and capable of being accessed by processor 1222 and storing data therein. Each of memory 1214 and memory 1224 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 1214 and memory 1224 may include a type of read-only memory (ROM) such as mask ROM, programmable ROM (PROM), erasable programmable ROM (EPROM) and/or electrically erasable programmable ROM (EEPROM). Alternatively or additionally, each of memory 1214 and memory 1224 may include a type of non-volatile random-access memory (NVRAM) such as flash memory, solid-state memory, ferroelectric RAM (FeRAM), magnetoresistive RAM (MRAM) and/or phase-change memory.

In some implementations, apparatus 1210 and/or apparatus 1220 may be configured as a sender or a recipient. The sender may be used for representing a node transmitting signals in a data link. The recipient may be used for representing a node receiving signals in a data link. In addition to performing data transmission, apparatus 1210 and/or apparatus 1220 may be able to perform functions such as transmitting a signal which may be used to facilitate sensing based coordination or interference management.

In some implementations, apparatus 1210 and/or apparatus 1220 may be configured as a sensed node or a sensing node. The sensed node may stand for a node from a first link generating a signal which may be sensed by another node from a second link. The sensing node may stand for a node from a second link sensing a signal which may be transmitted by another node from a first link.

In some implementations, when apparatus 1210 which may be configured as a UE is chosen to be the sensing node, the base station may provide a transmission grant including all transmission parameters (e.g., resource allocation, hybrid automatic repeat request (HARQ) ID) to apparatus 1210. Processor 1212 may be configured to make decisions in transmission according to a sensing result. The decisions may comprise at least one of determining whether to transmit signals or not, adjusting a transmission power level, and determining a modulation and coding scheme (MCS) level. As the base station may not know the MCS level chosen by processor 1212, processor 1212 may further indicate the chosen MCS level in the uplink transmission. On the other hand, when apparatus 1220 which may be configured as a base station is chosen to be the sensing node, processor 1222 may be configured to make decisions according to a sensing result. The decisions may comprise at least one of determining whether to transmit signals or not, adjusting a transmission power level, determining a modulation and coding scheme (MCS) level, and sending the chosen MCS level to the UE.

In some implementations, each of apparatus 1210 and apparatus 1220 may be configured as one of a first node, a second node, a third node and a fourth node, which may be a part of a wireless communication network. The first node may be a DL cell. The second node may be a DL UE. The third node may be a UL cell. The fourth node may be a UL UE. A first link may be established between the first node (e.g., DL cell) and the second node (e.g., DL UE) for DL data transmission. A second link may be established between the third node (e.g., UL cell) and the fourth node (e.g., UL UE) for UL data transmission.

In some implementations, apparatus 1210 may be configured as the DL cell and apparatus 1220 may be configured as the UL UE. Processor 1212 may be configured to sense the transmission from apparatus 1220 in the CCA region of a slot. The CCA region may be used by processor 1212 for sensing whether any signals may be transmitted from other nodes before transmitting the DL data to the DL UE. After sensing the transmission from apparatus 1220, processor 1212 may be configured to make decisions according to the sensing result. The decisions may comprise at least one of determining whether to transmit signals or not, adjusting a transmission power level and determining a MCS level. For example, if processor 1212 senses the transmission from apparatus 1220 (e.g., UL data), processor 1212 may determine not to transmit the DL data to the DL UE to avoid interfering the transmission from apparatus 1220. In the UL prioritized opportunistic transmission, the UL transmission between the UL cell and the UL UE may have higher priority. Accordingly, processor 1212 may have to sense before transmission and adjust its transmission according to the sensing result.

In some implementations, apparatus 1210 may be configured as the DL cell and apparatus 1220 may be configured as the UL UE. Processor 1222 may be configured to transmit a BT over the PRBs scheduled by the UL cell (e.g., the BT region of a slot). Processor 1212 may be configured to sense the transmission from apparatus 1220 in the CCA region of a slot. The CCA region may be used by processor 1212 for sensing whether any signals may be transmitted from other nodes before transmitting the DL data to the DL UE. The timing of the CCA region may correspond to the timing of the BT region. Accordingly, processor 1212 may sense the BT transmitted from apparatus 1220. After sensing the BT from apparatus 1220, processor 1212 may be configured to make decisions according to the sensing result. The decisions may comprise at least one of determining whether to transmit signals or not, adjusting a transmission power level and determining a MCS level. For example, if processor 1212 senses the beam direction of apparatus 1220 based on the BT transmitted from apparatus 1220, processor 1212 may determine not to transmit signals toward the beam direction of apparatus 1220 to avoid interfering the transmission from apparatus 1220.

In some implementations, apparatus 1210 may be configured as the DL cell and apparatus 1220 may be configured as the UL cell. Processor 1222 may be configured to transmit a BT in the BT region of a slot before receiving the UL data. Processor 1212 may be configured to sense the transmission from apparatus 1220 in the CCA region of a slot. The CCA region may be used by processor 1212 for sensing whether any signals may be transmitted from other nodes before transmitting the DL data to the DL UE. The timing of the BT region may correspond to the timing of the CCA region. Accordingly, processor 1212 may sense the BT transmitted from apparatus 1220. After sensing the BT from apparatus 1220, processor 1212 may be configured to make decisions according to the sensing result. The decisions may comprise at least one of determining whether to transmit signals or not, adjusting a transmission power level and determining a MCS level. For example, the BT may indicate that the UL transmission may occur at apparatus 1220. Processor 1212 may determine not to transmit signals to avoid interfering the UL transmission at apparatus 1220.

In some implementations, apparatus 1210 may be configured as the DL cell and apparatus 1220 may be configured as the UL cell. Processor 1222 may be configured to transmit the control information to the UL UE in the DLCC region of a slot. Processor 1212 may be configured to sense the transmission from apparatus 1220 in the CCA region of a slot. The CCA region may be used by processor 1212 for sensing whether any signals may be transmitted from other nodes before transmitting the DL data to the DL UE. The timing of the CCA region may correspond to the timing of the DLCC region. Accordingly, processor 1212 may sense the control information transmitted from apparatus 1220. After sensing the control information from apparatus 1220, processor 1212 may be configured to make decisions according to the sensing result. The decisions may comprise at least one of determining whether to transmit signals or not, adjusting a transmission power level and determining a MCS level. For example, the control information may comprise UL scheduling information for the UL UE. After sensing the control information, processor 1212 may be aware of that the UL transmission may occur at apparatus 1220 and may determine not to transmit signals to avoid interfering the UL transmission at apparatus 1220.

In some implementations, processor 1212 may firstly allocate the CCA region in a slot for sensing the control information from apparatus 1220, processor 1212 may shift the location of the DLCC region after the CCA region. Processor 1212 may be configured to transmit the downlink control information to the DL UE in the DLCC region after the CCA region. Accordingly, processor 1212 may further be configured to indicate the slot type or slot format to the DL UE in advance. The indication may be transmitted in the DL control information in a previous slot. Alternatively, if processor 1212 does not indicate the change of the slot type, the DL UE may need to blindly detect the control channel location.

In some implementations, each of apparatus 1210 and apparatus 1220 may be configured as one of a first node, a second node, a third node and a fourth node, which may be a part of a wireless communication network. The first node may be a UL UE. The second node may be a UL cell. The third node may be a DL UE. The fourth node may be a DL cell. A first link may be established between the first node (e.g., UL UE) and the second node (e.g., UE cell) for UL data transmission. A second link may be established between the third node (e.g., DL UE) and the fourth node (e.g., DL cell) for DL data transmission.

In some implementations, apparatus 1210 may be configured as the UL UE and apparatus 1220 may be configured as the DL cell. Processor 1222 may be configured to transmit the DL data to the DL UE in the DL data region of a slot. Processor 1212 may be configured to sense the transmission from apparatus 1220 in the CCA and gap region of a slot. In some implementations, the CCA region and the gap region may be combined together. The CCA region may be used by processor 1212 for sensing whether any signals may be transmitted from other nodes before transmitting the UL data to the UL cell. After sensing the transmission from apparatus 1220, processor 1212 may be configured to make decisions according to the sensing result. The decisions may comprise at least one of determining whether to transmit signals or not, adjusting a transmission power level and determining a MCS level. For example, if processor 1212 senses the transmission from apparatus 1220, processor 1212 may determine not to transmit the UL data to the UE cell to avoid interfering the transmission from apparatus 1220. In the DL prioritized opportunistic transmission, the DL transmission between the DL cell and the DL UE may have higher priority. Accordingly, processor 1212 may have to sense before transmission and adjust its transmission according to the sensing result.

In some implementations, apparatus 1210 may be configured as the UL UE and apparatus 1220 may be configured as the DL cell. Processor 1222 may be configured to transmit a BT over the scheduled DL PRBs (e.g., the BT region of a slot). Processor 1212 may be configured to sense the transmission from apparatus 1220 in the CCA region of a slot. The CCA region may be used by processor 1212 for sensing whether any signals may be transmitted from other nodes before transmitting the UL data to the UL cell. The timing of the CCA region of may correspond to the timing of the BT region. Accordingly, processor 1212 may sense the BT transmitted from apparatus 1220. After sensing the BT from apparatus 1220, processor 1212 may be configured to make decisions according to the sensing result. The decisions may comprise at least one of determining whether to transmit signals or not, adjusting a transmission power level and determining a MCS level. For example, if processor 1212 senses the beam direction of apparatus 1220 based on the BT transmitted from the apparatus 1220, processor 1212 may determine not to transmit signals toward the beam direction of apparatus 1220 to avoid interfering the transmission from apparatus 1220.

In some implementations, apparatus 1210 may be configured as the UL UE and apparatus 1220 may be configured as the DL UE. Processor 1222 may be configured to transmit a BT over the PRBs schedule by the DL cell (e.g., the BT region of a slot). Processor 1212 may be configured to sense the transmission from apparatus 1220 in the CCA region. The CCA region may be used by processor 1212 for sensing whether any signals may be transmitted from other nodes before transmitting the UL data to the UL cell. The timing of the CCA region may correspond to the timing of the BT region. Accordingly, processor 1212 may sense the BT transmitted from apparatus 1220. After sensing the BT from apparatus 1220, processor 1212 may be configured to make decisions according to the sensing result. The decisions may comprise at least one of determining whether to transmit signals or not, adjusting a transmission power level and determining a MCS level. For example, the BT may indicate that the DL transmission may occur at apparatus 1220. Processor 1212 may determine not to transmit signals to avoid interfering the DL transmission at apparatus 1220.

In some implementations, power control of the BT may provide some flexibility in the sensing based schemes. In other words, different levels of protections may be created by adjusting the transmission power of the BT. For example, if processor 1212 and/or processor 1222 detects that the signals from a sender may be weak, processor 1212 and/or processor 1222 may send out a BT with high power level to mute other nodes in an extended area surrounding the recipient. In this way, more sensing nodes may be prohibited from transmission or the sensing nodes may reduce its transmission power. Accordingly, apparatus 1210 and/or apparatus 1220 may get a better protection of its transmission and reception.

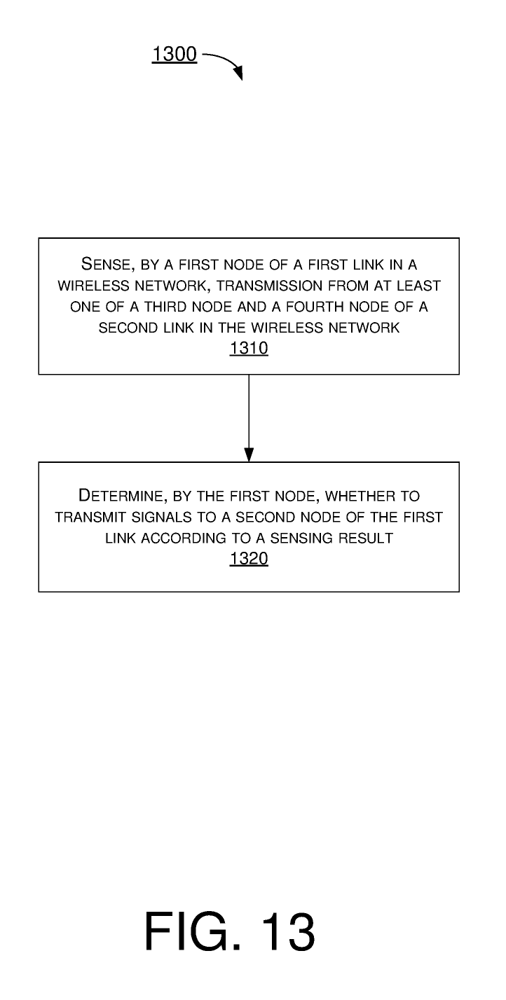

FIG. 13 illustrates an example process 1300 in accordance with an implementation of the present disclosure. Process 1300 may represent an aspect of implementing the proposed concepts and schemes such as one or more of the various schemes described above with respect to FIG. 1-FIG. 12. More specifically, process 1300 may represent an aspect of the proposed concepts and schemes pertaining to interference management in wireless communication systems. For instance, process 1300 may be an example implementation, whether partially or completely, of the proposed schemes described above for alert signal design in wireless communication systems. Process 1300 may include one or more operations, actions, or functions as illustrated by one or more of blocks 1310 and 1320. Although illustrated as discrete blocks, various blocks of process 1300 may be divided into additional blocks, combined into fewer blocks, or eliminated, depending on the desired implementation. Moreover, the blocks/sub-blocks of process 1300 may be executed in the order shown in FIG. 13 or, alternatively in a different order. The blocks of process 1300 may be executed iteratively. Process 1300 may be implemented by or in apparatus 1210 and/or apparatus 1220 as well as any variations thereof. Solely for illustrative purposes and without limiting the scope, process 1300 is described below in the context of apparatus 1210 and/or apparatus 1220. Process 1300 may begin at block 1310.

At 1310, process 1300 may involve apparatus 1310, as a first node of a first link in a wireless network, sensing transmission from at least one of a third node and a fourth node of a second link in the wireless network. Process 1300 may proceed from 1310 to 1320.

At 1320, process 1300 may involve apparatus 1310 determining whether to transmit signals to a second node of the first link according to a sensing result. The first link may be established between the first node and the second node. The second link may be established between the third node and the fourth node.

In some implementations, process 1300 may involve apparatus 1310 adjusting a transmission power level according to the sensing result.

In some implementations, process 1300 may involve apparatus 1310 determining a modulation and coding scheme (MCS) level according to the sensing result.

In some implementations, process 1300 may involve apparatus 1310 sensing the transmission in a clear channel assessment (CCA) region of a slot.

In some implementations, the first node may comprise a downlink cell. The fourth node may comprise an uplink UE. Process 1300 may involve apparatus 1310 sensing the uplink data transmitted from the uplink UE of the second link.

In some implementations, the first node may comprise a downlink cell. The fourth node may comprise an uplink UE. Process 1300 may involve apparatus 1310 sensing the BT transmitted from the uplink UE of the second link.

In some implementations, the first node may comprise a downlink cell. The third node comprises an uplink cell. Process 1300 may involve apparatus 1310 sensing the BT transmitted from the uplink cell of the second link.

In some implementations, the first node may comprise a downlink cell. The third node comprises an uplink cell. Process 1300 may involve apparatus 1310 sensing the control signals transmitted from the uplink cell of the second link.

In some implementations, process 1300 may involve apparatus 1310 transmitting the downlink control signals to the second node in a downlink control region after a CCA region of a slot.

In some implementations, the first node may comprise an uplink UE. The fourth node may comprise a downlink cell. Process 1300 may involve apparatus 1310 sensing the downlink data transmitted from the downlink cell of the second link.

In some implementations, the first node may comprise an uplink UE. The fourth node may comprise a downlink cell. Process 1300 may involve apparatus 1310 sensing the BT transmitted from the downlink cell of the second link.

In some implementations, the first node may comprise an uplink UE. The third node may comprise a downlink UE. Process 1300 may involve apparatus 1310 sensing the BT transmitted from the downlink UE of the second link.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
sensing, by a first node of a first link in a wireless network, transmission from at least one of a third node and a fourth node of a second link in the wireless network; and
determining, by the first node, whether to transmit signals to a second node of the first link according to a sensing result,
wherein the first link is established between the first node and the second node, and
wherein the second link is established between the third node and the fourth node.

2. The method of claim 1, further comprising:
adjusting, by the first node, a transmission power level according to the sensing result.

3. The method of claim 1, further comprising:
determining, by the first node, a modulation and coding scheme (MCS) level according to the sensing result.

4. The method of claim 1, wherein the sensing comprises sensing the transmission in a clear channel assessment (CCA) region of a slot.

5. The method of claim 1, wherein the first node comprises a downlink cell, wherein the fourth node comprises an uplink user equipment (UE), and wherein the sensing comprises sensing, by the downlink cell, uplink data transmitted from the uplink UE of the second link.

6. The method of claim 1, wherein the first node comprises a downlink cell, wherein the fourth node comprises an uplink UE, and wherein the sensing comprises sensing, by the downlink cell, a busy tone transmitted from the uplink UE of the second link.

7. The method of claim 1, wherein the first node comprises a downlink cell, wherein the third node comprises an uplink cell, and wherein the sensing comprises sensing, by the downlink cell, a busy tone transmitted from the uplink cell of the second link.

8. The method of claim 1, wherein the first node comprises a downlink cell, wherein the third node comprises an uplink cell, and wherein the sensing comprises sensing, by the downlink cell, control signals transmitted from the uplink cell of the second link.

9. The method of claim 8, further comprising:
transmitting, by the downlink cell, downlink control signals to the second node in a downlink control region after a CCA region of a slot,
wherein the second node comprises a downlink UE.

10. The method of claim 1, wherein the first node comprises an uplink UE, wherein the fourth node comprises a downlink cell, and wherein the sensing comprises sensing, by the uplink UE, downlink data transmitted from the downlink cell of the second link.

11. The method of claim 1, wherein the first node comprises an uplink UE, wherein the fourth node comprises a downlink cell, and wherein the sensing comprises sensing, by the uplink UE, a busy tone transmitted from the downlink cell of the second link.

12. The method of claim 1, wherein the first node comprises an uplink UE, wherein the third node comprises a downlink UE, and wherein the sensing comprises sensing, by the uplink UE, a busy tone transmitted from the downlink UE of the second link.

13. An apparatus implementable in a first node of a first link in a wireless network, comprising:
a transceiver capable of wirelessly communicating with a plurality of nodes of the wireless network; and
a processor communicatively coupled to the transceiver, the processor capable of:
sensing transmission from at least one of a third node and a fourth node of a second link in the wireless network; and
determining whether to transmit signals to a second node of the first link according to a sensing result,
wherein the first link is established between the first node and the second node, and
wherein the second link is established between the third node and the fourth node.

14. The apparatus of claim 13, wherein the processor is further capable of:
adjusting a transmission power level according to the sensing result.

15. The apparatus of claim 13, wherein the processor is further capable of:
determining a modulation and coding scheme (MCS) level according to the sensing result.

16. The apparatus of claim 13, wherein, in sensing the transmission, the processor senses the transmission in a clear channel assessment (CCA) region of a slot.

17. The apparatus of claim 13, wherein the first node comprises a downlink cell, wherein the fourth node comprises an uplink UE, and wherein, in sensing the transmission, the processor senses uplink data transmitted from the uplink UE of the second link.

18. The apparatus of claim 13, wherein the first node comprises a downlink cell, wherein the fourth node comprises an uplink UE, and wherein, in sensing the transmission, the processor senses a busy tone transmitted from the uplink UE of the second link.

19. The apparatus of claim 13, wherein the first node comprises a downlink cell, wherein the third node comprises an uplink cell, and wherein, in sensing the transmission, the processor senses a busy tone transmitted from the uplink cell of the second link.

20. The apparatus of claim 13, wherein the first node comprises a downlink cell, wherein the third node comprises an uplink cell, and wherein, in sensing the transmission, the processor senses control signals transmitted from the uplink cell of the second link.
